(19) United States
(12) Patent Application Publication
(10) Pub. No.: US 2026/0213333 A1
(43) Pub. Date: Jul. 23, 2026

(54) THERMAL PROPAGATION MANAGEMENT SYSTEM AND METHOD

(71) Applicant: GM GLOBAL TECHNOLOGY OPERATIONS LLC, Detroit, MI (US)

(72) Inventors: Chinmaya Patil, South Lyon, MI (US); Xiaoling Chen, Sterling Heights, MI (US); Derek F. Lahr, Ann Arbor, MI (US); Simon J. H. Trask, Royal Oak, MI (US); Sean M. Welch, Bruce Twp., MI (US); Teresa U. Holiness-Stalling, Detroit, MI (US); John P. Spicer, Plymouth, MI (US)

(73) Assignee: GM GLOBAL TECHNOLOGY OPERATIONS LLC, Detroit, MI (US)

(21) Appl. No.: 19/016,431

(22) Filed: Jan. 10, 2025

(51) Int. Cl. H01M 50/367; H01M 10/653; H01M 10/658; H01M 50/204; H01M 50/249; H01M 50/282; H01M 50/342

(52) U.S. Cl. CPC H01M 50/367; H01M 10/653; H01M 10/658; H01M 50/249; H01M 50/282; H01M 50/3425; H01M 50/204

(57) ABSTRACT

A rechargeable energy storage system (RESS) for a vehicle having thermal propagation vent gas management includes at least one battery module disposed within the RESS. The at least one battery module includes a battery module tray, a plurality of individual battery cells disposed within the battery module tray, a battery module cover arranged adjacent to a first side of the battery module tray, and a thermal propagation (TRP) hat arranged adjacent to a venting side of the plurality of individual battery cells. The TRP hat includes a diverter plate having a plurality of vent gas diverters, and a mica burst sheet arranged adjacent to the diverter plate. The TRP hat and the battery module cover define an expansion chamber.

### INTRODUCTION

The concepts described herein relate generally to rechargeable energy storage systems (RESS) that include at least one battery module configured to manage vent gas to mitigate effects of a thermal propagation event within the RESS.

Each battery module within the RESS may include a plurality of battery cell groups or packs, with each battery cell group including a plurality of battery cells, for example, lithium-ion battery cells.

Direct current (DC) power sources, such as lithium-ion batteries, may be employed to store and release electric power that may be employed by an electric circuit or an electric machine to perform work, such as for communications, display, or propulsion. Heat may be generated by the processes of converting electric power to chemical potential energy, i.e., battery charging, and converting chemical potential energy to electric power, i.e., battery discharging.

### SUMMARY

It is useful to develop a rechargeable energy storage system (RESS) including battery modules having thermal vent gas management features. Each battery module includes a plurality of battery cells having a thermal propagation (TRP) hat and a preformed potting that are operable to redirect vent gases and/or ejecta from an individual battery cell experiencing thermal propagation into an expansion chamber to facilitate cooling, and seal the vent gases and/or ejecta from adjacent battery cells.

A rechargeable energy storage system (RESS) for a vehicle having thermal vent gas management may be provided herein including at least one battery module disposed within the RESS. The at least one battery module may include a battery module tray, a plurality of individual battery cells disposed within the battery module tray, a battery module cover arranged adjacent to a first side of the battery module tray, and a TRP hat arranged adjacent to a venting side of the plurality of individual battery cells, such that the TRP hat and the battery module cover may define an expansion chamber.

The TRP hat may include a diverter plate, and a mica burst sheet arranged adjacent to the diverter plate.

The diverter plate may include a plurality of vent gas diverters, and the diverter plate may include a thermally and electrically isolating coating, which may be applied prior the diverter plate prior to stamping or punching to prevent arcing.

According to one aspect of the disclosure, the diverter plate may include multiple sections.

The mica burst sheet may include a plurality of burst sections, and a border section. The plurality of burst sections may have a first thickness, and the border section may have a second thickness that may be greater than the first thickness.

Each of the plurality of burst sections may be arranged adjacent to a respective one of the plurality of individual battery cells.

The at least one battery module may further include a preformed potting arranged between the plurality of individual battery cells.

According to one aspect of the disclosure, the venting side of the plurality of individual battery cells may be arranged vertically upward within the battery module.

The plurality of vent gas diverters may include shaped diverters that protrude into the expansion chamber including but not limited to triangular hooded vent gas diverters, and/or curved hooded vent gas diverters.

According to another aspect of the disclosure, the venting side of the plurality of individual battery cells may be arranged vertically downward within the battery module.

The plurality of vent gas diverters may include lay-flat diverters that are coplanar with the diverter plate.

According to another aspect of the disclosure, a rechargeable energy storage system (RESS) for a vehicle having thermal vent gas management may include at least one battery module disposed within the RESS.

The at least one battery module may include a battery module tray, a plurality of individual battery cells disposed within the battery module tray, and a battery module cover arranged adjacent to a first side of the battery module tray.

The battery module cover may include a backing, a mica layer arranged adjacent to the backing, and a thermal propagation (TRP) hat arranged adjacent to a venting side of the plurality of individual battery cells.

The TRP hat may include a diverter plate having a plurality of vent gas diverters, and a mica burst sheet that may be arranged adjacent to the diverter plate.

The mica burst sheet may include a plurality of burst sections, a border section, a preformed potting arranged between the plurality of individual battery cells, and an interconnect board (ICB) busbar arranged between the TRP hat and the preformed potting.

The plurality of burst sections may have a first thickness, and the border section may have a second thickness that is greater than the first thickness.

The TRP hat and the battery module cover may define an expansion chamber.

The diverter plate may include a thermally and electrically isolating coating, which may be applied prior the diverter plate prior to stamping or punching to prevent arcing.

The diverter plate includes multiple sections including for example but not limited to a first section, a second section, a third section, and/or a fourth section.

A vehicle including a rechargeable energy storage system (RESS) having thermal vent gas management may also be provided herein.

The vehicle may include an electric motor-generator configured to generate a power-source torque for propulsion of the vehicle, and a RESS configured to supply electrical energy to the electric motor-generator.

The RESS may include at least one battery module disposed within the RESS.

The at least one battery module may include a battery module tray, a plurality of individual battery cells disposed within the battery module tray, a battery module cover arranged adjacent to a first side of the battery module tray, and a thermal propagation (TRP) hat arranged adjacent to a venting side of the plurality of individual battery cells.

The TRP hat and the battery module cover may define an expansion chamber.

The TRP hat may include a diverter plate, and a mica burst sheet that may be arranged adjacent to the diverter plate.

The diverter plate may include a plurality of vent gas diverters.

The mica burst sheet may include a plurality of burst sections, and a border section. The plurality of burst sections may have a first thickness, and the border section may have a second thickness that may be greater than the first thickness.

Each of the plurality of burst sections may be arranged adjacent to a respective one of the plurality of individual battery cells.

The at least one battery module may include a preformed potting arranged between the plurality of individual battery cells.

As such, thermal vent gas management may be provided herein by including a TRP hat including a diverter plate and mica burst sheet arranged adjacent to a top end of the plurality of battery cells within in the battery module, and preformed potting arranged between the plurality of battery cells.

The diverter plate may direct vent gases and/or ejecta into the expansion chamber away from vents disposed in a battery module cover to cool, and then toward the vents disposed in the battery module to be exhausted.

The mica burst sheet and preformed potting seal vent gas and/or ejecta blow back into the expansion chamber, protecting the adjacent battery cells.

Venting the gases and/or ejecta from the battery cell experiencing a thermal event, redirecting the vent gases and/or ejecta into an expansion chamber, and sealing the vent gases and/or the ejecta from entering adjacent battery cells may prevent a temperature of the adjacent battery cells from exceeding a thermal propagation threshold temperature.

Therefore, by including a thermal propagation hat including a vent gas diverter plate, and a mica burst sheet arranged adjacent to a top end of battery cells disposed within a battery module, that is disposed within an RESS, hot vent gases and ejecta from a battery cell experiencing a thermal event may be redirected into an expansion chamber to facilitate cooling, and sealed from entering adjacent battery cells that are not experiencing thermal propagation.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure which, taken together with the description, serve to explain the principles of the disclosure.

FIG. 1 is a schematic illustration of a vehicle including a rechargeable energy storage system (RESS) including a plurality of battery module in accordance with the present disclosure.

FIG. 2 is a schematic illustration of a portion of a RESS including a plurality of battery modules in accordance with the present disclosure.

FIG. 3 is a schematic illustration of a battery module in accordance with the present disclosure.

FIG. 3A is a schematic illustration of a cross-section of an exploded portion of a battery module illustrated in FIG. 3 in accordance with the present disclosure.

FIG. 4 is a schematic illustration of a cross-section of an assembled portion of a battery module illustrated in FIG. 3 in accordance with the present disclosure.

FIG. 4A is a schematic illustration of a portion of diverter plate in accordance with the present disclosure.

FIG. 4A-1 is a schematic illustration of lay-flat vent gas diverters in accordance with one aspect of the present disclosure.

FIG. 4A-2 is a schematic illustration of a triangular hooded vent gas diverter in accordance with the present disclosure.

FIG. 4A-3 is a schematic illustration of a curved hooded vent gas diverter in accordance with the present disclosure.

FIG. 4B is a schematic illustration of a mica burst sheet in accordance with the present disclosure.

The appended drawings are not necessarily to scale, and may present a somewhat simplified representation of various preferred features of the present disclosure as disclosed herein, including, for example, specific dimensions, orientations, locations, and shapes. Details adjacent to such features will be determined in part by the particular intended application and use environment.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof.

Referring now to the drawings, wherein like numerals indicate like parts in several views, a rechargeable energy storage system (RESS) for a vehicle having thermal propagation mitigation, including battery modules having a thermal barrier disposed at end portion of each battery module, and method of mitigating undesirable effects of thermal propagation, are shown and described herein.

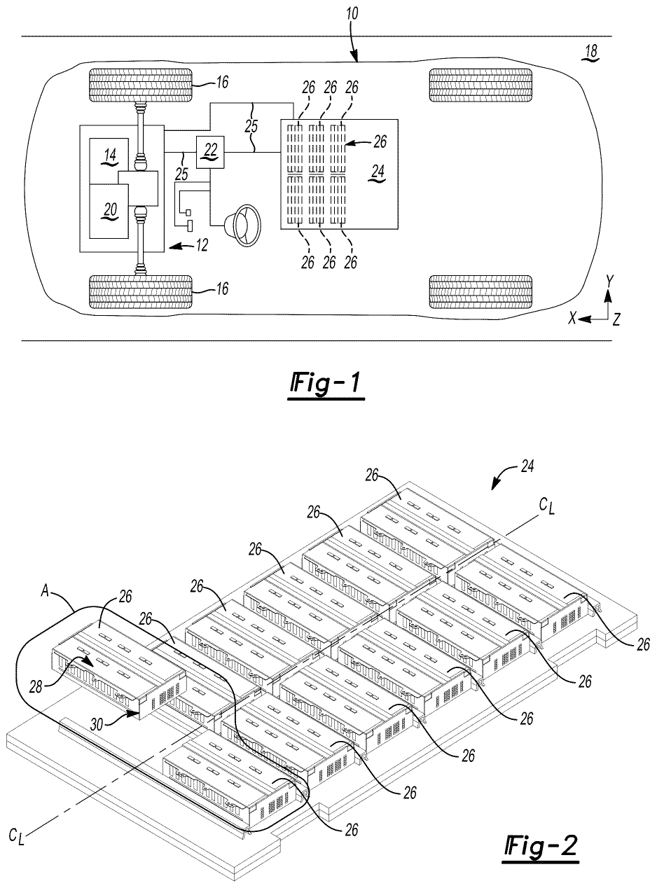

As illustrated in FIG. 1, a vehicle 10 includes a powertrain 12. The vehicle 10 may include, but is not limited to, a commercial vehicle, an industrial vehicle, a passenger vehicle, an aircraft, a watercraft, a train or the like. It is also contemplated that the vehicle 10 may include a mobile platform, such as an airplane, an all-terrain vehicle (ATV), a boat, a personal movement apparatus, a robot and the like to accomplish the purposes of this disclosure.

The powertrain 12 includes a power-source 14 configured to generate a power-source torque T (not shown) for propulsion of the vehicle 10 via driven wheels 16 relative to a road surface 18. The power-source 14 is depicted as an electric motor-generator.

The powertrain 12 may also include an additional power-source 20, such as an internal combustion engine. The power-sources 14 and 20 may act in concert to power the vehicle 10. The vehicle 10 additionally includes a programmable electronic controller 22 and a rechargeable energy storage system (RESS) 24 configured to generate and store electrical energy through heat-producing electro-chemical reactions for supplying the electrical energy to the power-sources 14 and 20. The electronic controller 22 may be programmed to control the powertrain 12 and the RESS 24 to generate a predetermined amount of power-source torque T, and various other vehicle systems.

The electronic controller 22 may include a central processing unit (CPU) that regulates various functions on the vehicle 10, or be configured as a powertrain control module (PCM) configured to control the powertrain 12.

In either of the above configurations, the electronic controller 22 includes a processor and tangible, non-transitory memory, which includes instructions for operation of the powertrain 12 and the RESS 24 programmed therein. The memory may be an appropriate recordable medium that participates in providing computer-readable data or process instructions. Such a recordable medium may take many forms, including, but not limited to, non-volatile media and volatile media.

Non-volatile media for the electronic controller 22 may include, for example, optical or magnetic disks and other persistent memory. Volatile media may include, for example, dynamic random access memory (DRAM), which may constitute a main memory. Such instructions may be transmitted by one or more transmission medium, including coaxial cables, copper wire and fiber optics, including the wires that comprise a system bus coupled to a processor of a computer, or via a wireless connection.

Memory of the electronic controller 22 may also include a flexible disk, hard disk, magnetic tape, another magnetic medium, a CD-ROM, DVD, another optical medium, etc. The electronic controller 22 may be configured or equipped with other required computer hardware, such as a high-speed clock, requisite Analog-to-Digital (A/D) and/or Digital-to-Analog (D/A) circuitry, input/output circuitry and devices (I/O), as well as appropriate signal conditioning and/or buffer circuitry. Algorithms required by the electronic controller 22 or accessible thereby may be stored in the memory and automatically executed to provide the required functionality of the powertrain 12 and the RESS 24.

The RESS 24, which may be connected to the power-sources 14 and 20, the electronic controller 22, as well as other vehicle systems via a high-voltage bus 25, includes a plurality of battery modules 26 disposed within the RESS 24.

Operation of the powertrain 12 and the RESS 24 is generally regulated by the electronic controller 22.

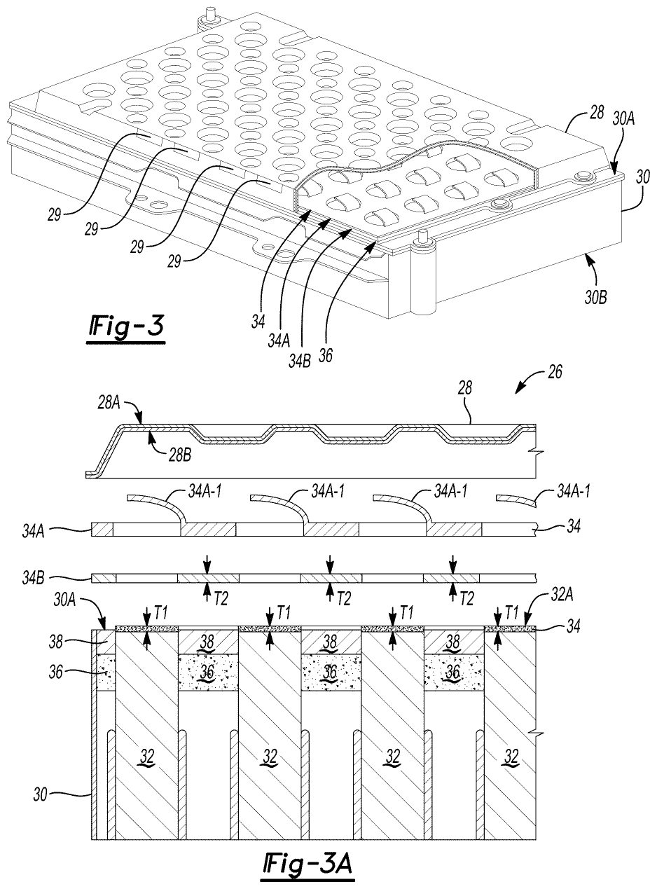

As schematically illustrated in FIG. 2, according to the present disclosure, a rechargeable energy storage system (RESS) 24 includes a plurality of battery modules 26 disposed within the RESS 24, each battery module 26 having a battery module cover 28 and a battery module tray 30.

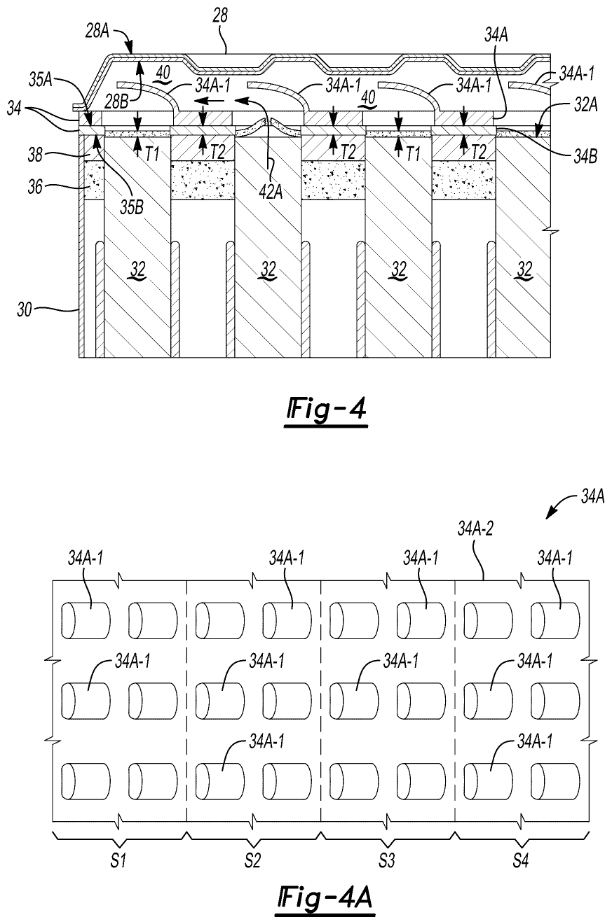

As schematically illustrated in FIG. 3 and FIG. 3A, each battery module 26 includes a battery module cover 28 having a plurality of vents 29, a battery module tray 30, and a plurality of individual battery cells 32 disposed within the battery module 26.

The battery module cover 28 is arranged adjacent to a first side 30A of the battery module tray 30, a thermal propagation (TRP) hat 34 arranged adjacent to a venting side 32A of the plurality of individual battery cells 32, an interconnect board (ICB) busbar 36, and a preformed potting 38 arranged between the plurality of individual battery cells 32.

The battery module cover 28 includes an outer layer 28A, which may include for example but not limited to an aluminum outer layer, and an inner layer 28B, which may include for example, a mica layer.

The TRP hat 34 includes a diverter plate 34A having a plurality of vent gas diverters 34A-1, and a mica burst sheet 34B arranged adjacent to the diverter plate 34A.

Each of the plurality of vent gas diverters 34A-1 is arranged adjacent to a respective one of the plurality of individual battery cells 32.

According to one aspect of the disclosure, the diverter plate 34A includes a thermally and electrically isolating coating (not shown). which may be applied prior the diverter plate 34A prior to stamping or punching to prevent arcing.

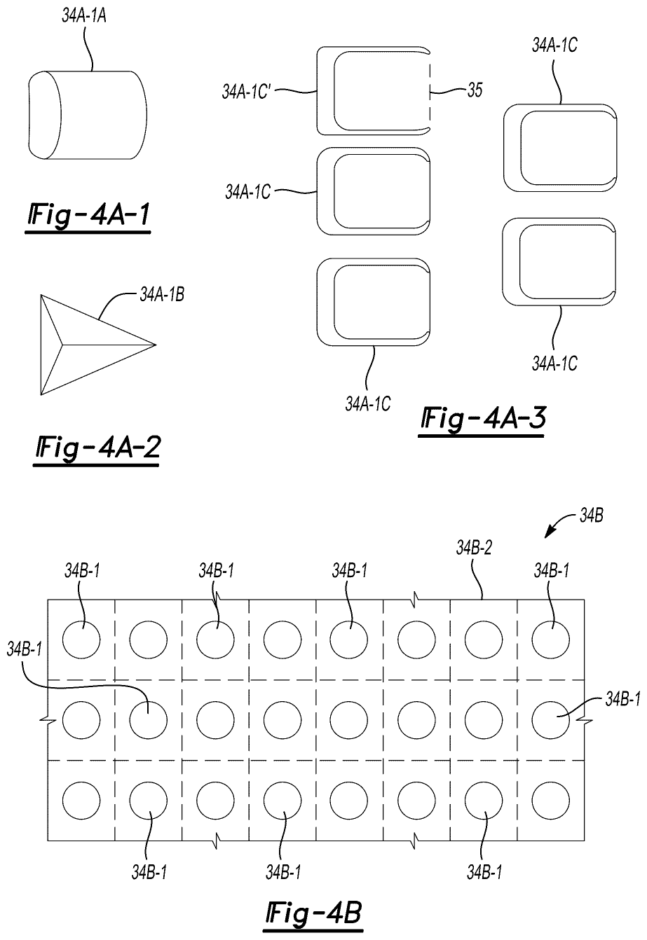

When assembled, as illustrated in FIG. 4, the TRP hat 34 and the battery module cover 28 define an expansion chamber 40.

During a thermal event, vent gases and/or ejecta, illustrated at 42, burst through the mica burst sheet 34B, travel through the diverter plate 34A, and are directed into the expansion chamber 40 by vent gas diverters 34A-1 to cool within the expansion chamber 40 before being exhausted of the battery module 26 through the plurality of vents 29 disposed in the battery module cover 28.

Additionally, the diverter plate 34A acts as a backing plate for the mica burst sheet 34B, supporting a clean rupture of the mica burst sheet 34B and providing a seal between the battery cell 32 experiencing a thermal event and battery cells 32 adjacent to the battery cell 32 experiencing the thermal event.

It should be appreciated that the plurality of vent gas diverters 34A-1 may be arranged within the diverter plate 34A to direct the vent gases 42 along a first path towards the closest of the plurality of vents in the battery module cover 28 to exhaust the vent gases 42 or, alternatively, the plurality of vent gas diverters 34A-1 may direct the vent gases 42 along an alternate cooling path away from the closest of the plurality of vents 29 disposed in the battery module cover 28 prior to exhausting the vent gases 42 depending on cooling requirements.

The preformed potting 38 provides sealing between the plurality of battery cells 32 to lock out the vent gases 42 from the battery cell 32 experiencing the thermal propagation event from reaching the battery cells 32 adjacent to the battery cell 32 experiencing the thermal propagation event, and facilitates the vent cases 42 routing into the TRP hat 34.

The preformed potting 38 also provides thermal insulation between the plurality of battery cells 32, and mechanical integrity to the battery module 26.

According to one aspect of the disclosure, as illustrated in FIG. 4A, a diverter plate 34A includes a plurality of vent gas diverters 34A-1. The diverter plate 34A may include multiple sections, for example but not limited to a first section S1, a second section S2, a third section S3, and/or a fourth section S4, to facilitate assembly of the diverter plate 34A to the battery module 26, and to electrically isolate sections of the diverter plate 34A to mitigate arcing due to vent gases.

As illustrated in FIGS. 4A-1 and 4A-2, it should also be appreciated that the plurality of vent gas diverters 34A-1 may include shaped diverters that protrude into the expansion chamber 40, for example but not limited to curved hooded vent gas diverters 34A-1A (FIG. 4A-1), and/or a triangular hooded vent gas diverter 34A-1B (FIG. 4A-2), as required to optimize vent gas expansion and/or cooling. The shaped diverters may be formed from, for example but not limited to blank plates using a punch and/or a die.

According to one aspect of the disclosure. as illustrated in FIG. 4A-3, the vent gas diverters may include lay-flat vent gas diverters 34A-1C, which may include a hinge 35 as illustrated at 34A-1C′.

As illustrated in FIG. 4C, a mica burst sheet 34B includes a plurality of burst sections 34B-1 and a border section 34B-2. Each of the plurality of burst sections 34B-1 has a first thickness T1. The border section 34B-2 has a second thickness T2 that is greater than the first thickness T1 (FIG. 3A and FIG. 4).

Referring back to FIG. 4, a first side 35A of the mica burst sheet 34B is arranged adjacent to the plurality of battery cells 32, while a second side 35B of the mica burst sheet 34B is arranged adjacent to the diverter plate 34A.

Each of the plurality of burst sections 34B-1 of the mica burst sheet 34B is arranged adjacent to a respective one of the plurality of individual battery cells 32.

Each of the plurality of battery modules 26 includes a preformed potting 38 arranged between the plurality of individual battery cells 32.

The mica burst sheet 34B and preformed potting 38 seal the vent gas and/or ejecta 42 into the expansion chamber 40, protecting the battery cells 32 adjacent to the battery cell 32 experiencing the thermal propagation event.

According to one aspect of the disclosure, a venting side 32A of the plurality of individual battery cells 32 is arranged vertically upward within the battery module 26.

While the venting side 32A is illustrated as being vertically upward within the battery module 26, it should be appreciated that, according to another aspect of the disclosure, the venting side 32A of the plurality of individual battery cells 32 may be arranged vertically downward within the battery module 26.

According to another aspect of the disclosure, a rechargeable energy storage system (RESS) 24 for a vehicle 10 having thermal propagation vent gas management is disclosed herein.

The RESS 24 includes at least one battery module 26 disposed within the RESS 24. The at least one battery module 26 includes a battery module tray 30, a plurality of individual battery cells 32 disposed within the battery module tray 30, a battery module cover 28 arranged adjacent to a first side 30A of the battery module 26.

The battery module cover 28 includes an outer layer 28A, and a mica layer 28B arranged adjacent to the outer layer 28A, a thermal propagation (TRP) hat 34 arranged adjacent to a venting side 32A of the plurality of individual battery cells 32.

The TRP hat 34 includes a diverter plate 34A including a plurality of vent gas diverters 34A-1, and a mica burst sheet 34B arranged adjacent to the diverter plate 34A.

The mica burst sheet 34B includes a plurality of burst sections 34B-1 having a first thickness T1, and a border section 34B-2 having a second thickness T2 that is greater than the first thickness T1.

A preformed potting 38 is arranged between the plurality of individual battery cells 32.

An interconnect board (ICB) busbar 36 is arranged between the TRP hat 34 and the preformed potting 38.

The TRP hat 34 and the battery module cover 28 define an expansion chamber 40.

According to one aspect of the disclosure, the diverter plate 34A may include a thermally and electrically isolating coating (not shown), which may be applied prior the diverter plate 34A prior to stamping or punching to prevent arcing.

According to one aspect of the disclosure, the diverter plate 34A includes multiple sections, for example but not limited to a first section S1, a second section S2, a third section S3, and/or a fourth section S4, as required to facilitate assembly of the diverter plate 34A to the battery module 26, and to electrically isolate sections of the diverter plate 34A to mitigate arcing due to vent gases.

According to another aspect of the disclosure, a vehicle 10 including a rechargeable energy storage system (RESS) 24 for a vehicle 10 having thermal vent gas management is disclosed herein.

The vehicle 10 includes an electric motor-generator 14 configured to generate a power-source torque for propulsion of the vehicle 10, and a RESS 24 configured to supply electrical energy to the electric motor-generator 14. The RESS 24 includes thermal propagation vent gas management as discussed above.

Venting the gases and/or ejecta from the individual battery cell experiencing a thermal propagation event, redirecting the vent gases and/or ejecta into an expansion chamber, and sealing the vent gases and/or the ejecta from entering adjacent battery cells prevents the temperature of the adjacent battery cells from exceeding a thermal propagation threshold temperature.

Therefore, by including a thermal propagation hat including a vent gas diverter plate, and a mica burst sheet arranged adjacent to a top end of battery cells disposed within a battery module, that is disposed within a rechargeable energy storage system (RESS), vent gases and ejecta from a battery cell experiencing a thermal propagation event may be redirected into an expansion chamber to facilitate cooling, and sealed from entering adjacent battery cells that are not experiencing thermal propagation preventing thermal propagation of the thermal from the adjacent battery cells.

These and other attendant benefits of the present disclosure will be appreciated by those skilled in the art in view of the foregoing disclosure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A rechargeable energy storage system (RESS) for a vehicle having thermal propagation vent gas management, the RESS comprising:
at least one battery module disposed within the RESS, wherein the at least one battery module includes:
a battery module tray;
a plurality of individual battery cells disposed within the battery module tray;
a battery module cover arranged adjacent to a first side of the battery module tray; and
a thermal propagation (TRP) hat arranged adjacent to a venting side of the plurality of individual battery cells, wherein the TRP hat and the battery module cover define an expansion chamber.

2. The RESS as recited in claim 1, wherein the TRP hat includes:
a diverter plate; and
a mica burst sheet arranged adjacent to the diverter plate.

3. The RESS as recited in claim 2, wherein the diverter plate includes a plurality of vent gas diverters.

4. The RESS as recited in claim 3, wherein the plurality of vent gas diverters include shaped vent gas diverters that protrude into the expansion chamber.

5. The RESS as recited in claim 3, wherein the plurality of vent gas diverters include lay-flat vent gas diverters that are coplanar with the diverter plate.

6. The RESS as recited in claim 2, wherein the diverter plate includes a thermally and electrically isolating coating.

7. The RESS as recited in claim 2, wherein the diverter plate includes multiple sections.

8. The RESS as recited in claim 2, wherein the mica burst sheet includes:
a plurality of burst sections having a first thickness; and
a border section having a second thickness that is greater than the first thickness, wherein each of the plurality of burst sections is arranged adjacent to a respective one of the plurality of individual battery cells.

9. The RESS as recited in claim 2, wherein the at least one battery module includes a preformed potting arranged between the plurality of individual battery cells.

10. The RESS as recited in claim 1, wherein the venting side of the plurality of individual battery cells is arranged vertically upward within the battery module.

11. The RESS as recited in claim 1, wherein the venting side of the plurality of individual battery cells is arranged vertically downward within the battery module.

12. A rechargeable energy storage system (RESS) for a vehicle having thermal propagation vent gas management, the rechargeable energy storage system comprising:
at least one battery module disposed within the rechargeable energy storage system, wherein the at least one battery module includes:
a battery module tray;
a plurality of individual battery cells disposed within the battery module tray;
a battery module cover arranged adjacent to a first side of the battery module tray, wherein the battery module cover includes:
a backing; and
a mica layer arranged adjacent to the backing;
a thermal propagation (TRP) hat arranged adjacent to a venting side of the plurality of individual battery cells, wherein the TRP hat includes:
a diverter plate including a plurality of vent gas diverters; and
a mica burst sheet arranged adjacent to the diverter plate, wherein the mica burst sheet includes a plurality of burst sections having a first thickness, and a border section having a second thickness that is greater than the first thickness;
a preformed potting arranged between the plurality of individual battery cells; and
an interconnect board (ICB) busbar arranged between the TRP hat and the preformed potting.

13. The RESS as recited in claim 12, wherein the TRP hat and the battery module cover define an expansion chamber.

14. The RESS as recited in claim 12, wherein the diverter plate includes a thermally and electrically isolating coating.

15. The RESS as recited in claim 12, wherein the diverter plate includes multiple sections.

16. A vehicle comprising:
an electric motor-generator configured to generate a power-source torque for propulsion of the vehicle; and
a rechargeable energy storage system (RESS) configured to supply electrical energy to the electric motor-generator, the RESS having thermal propagation vent gas management, the RESS comprising:
at least one battery module disposed within the RESS, wherein the at least one battery module includes:
a battery module tray;
a plurality of individual battery cells disposed within the battery module tray;
a battery module cover arranged adjacent to a first side of the battery module tray; and
a thermal propagation (TRP) hat arranged adjacent to a venting side of the plurality of individual battery cells, wherein the TRP hat and the battery module cover define an expansion chamber.

17. The vehicle as recited in claim 16, wherein the TRP hat includes:
a diverter plate; and
a mica burst sheet arranged adjacent to the diverter plate.

18. The vehicle as recited in claim 17, wherein the diverter plate includes a plurality of vent gas diverters.

19. The vehicle as recited in claim 17, wherein the mica burst sheet includes:
a plurality of burst sections having a first thickness; and
a border section having a second thickness that is greater than the first thickness, wherein each of the plurality of burst sections is arranged adjacent to a respective one of the plurality of individual battery cells.

20. The vehicle as recited in claim 17, wherein the at least one battery module includes a preformed potting arranged between the plurality of individual battery cells.
